(19) United States
(12) Patent Application Publication
(10) Pub. No.: US 2024/0324683 A1
(43) Pub. Date: Oct. 3, 2024

(54) AEROSOL PROVISION DEVICE COMPRISING AN ELECTROMAGNETIC SHIELD MEMBER

(71) Applicant: Nicoventures Trading Limited, London (GB)

(72) Inventors: Jonathon Neil BURGESS, London (GB); Conor MCGRATH, London (GB)

(21) Appl. No.: 18/579,734

(22) PCT Filed: Jul. 15, 2022
(86) PCT No.: PCT/EP2022/069913

§ 371 Date: Jan. 16, 2024

(30) Foreign Application Priority Data
Jul. 15, 2021 (GB) 2110218.1

(51) Int. Cl. A24F 40/465; A24F 40/20; C08K 3/04; C08K 3/14; C08K 3/22; C08K 3/28; H05B 6/10

(52) U.S. Cl. CPC A24F 40/465; A24F 40/20; C08K 3/04; C08K 3/14; C08K 3/22; C08K 3/28; H05B 6/108; C08K 2201/001

(57) ABSTRACT

An aerosol provision device includes a receptacle configured to receive aerosol generating material, wherein the aerosol generating material is heatable by a susceptor; an inductor coil configured to generate a varying magnetic field for heating the susceptor; and an electromagnetic shield member at least partially covering the inductor coil, wherein the electromagnetic shield member includes a polymeric composition which is configured to absorb and/or reflect electromagnetic radiation.

### RELATED APPLICATIONS

The present application is a National Phase entry of PCT Application No. PCT/EP2022/069913 filed Jul. 15, 2022, which claims priority to GB Application No. 2110218.1 filed Jul. 15, 2021, each of which is hereby incorporated by reference in their entirety.

### TECHNICAL FIELD

The present invention relates to an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device comprising:
a receptacle configured to receive aerosol generating material, wherein the aerosol generating material is heatable by a susceptor;
an inductor coil configured to generate a varying magnetic field for heating the susceptor; and
an electromagnetic shield member at least partially covering the inductor coil, wherein the electromagnetic shield member comprises a polymeric composition.

In embodiments, the polymeric composition is configured to absorb and/or reflect electromagnetic radiation.

In embodiments, the polymeric composition comprises (i) a polymer and (ii) filler which is capable of absorbing and/or reflecting electromagnetic radiation.

In embodiments, the polymeric composition consists essentially of (i) a polymer and (ii) filler which is capable of absorbing and/or reflecting electromagnetic radiation.

In embodiments, the polymeric composition consists of (i) a polymer and (ii) filler which is capable of absorbing and/or reflecting electromagnetic radiation.

In embodiments, the polymeric composition has a shielding effectiveness of at least about 20 dB, when measured at 30 MHz.

In embodiments, the polymeric composition has a shielding effectiveness of at least about 40 dB, when measured at 30 MHz.

In embodiments, the polymeric composition has a shielding effectiveness of from about 30 to about 80 dB, when measured at 30 MHz.

In embodiments, the polymeric composition has a shielding effectiveness of from about 40 to about 70 dB, when measured at 30 MHz.

In embodiments, the polymeric composition has a surface resistance of about 10⁵ Ohm or less.

In embodiments, the polymeric composition has a surface resistance of about 10⁴ Ohm or less.

In embodiments, the polymeric composition has a surface resistance of about 100 Ohm or less.

In embodiments, the polymeric composition has a surface resistance of from about 0.01 to about 10 Ohm.

In embodiments, the polymeric composition has a thickness of from about 0.10 to about 2 mm.

In embodiments, the polymeric composition has a thickness of from about 0.15 to about 1.5 mm.

In embodiments, the electromagnetic shield member is in contact with the inductor coil.

In embodiments, the polymer is an elastomer or a thermoplastic polymer.

In embodiments, the polymer is selected from the group consisting of polycarbonate (PC), polyethylenimine (PEI), acrylonitrile butadiene styrene (ABS), polystyrene (PS), polyvinyl chloride (PVC), PVC alloys, cyclic olefin copolymer (COC), poly(methyl methacrylate) (PMMA), polypropylene carbonate (PPC), polyether ether ketone (PEEK), polybutylene terephthalate (PBT), polyethylene terephthalate (PET), polyoxymethylene (POM), nylon), polyethylene (PE), polypropylene (PP), thermoplastic polyurethane (TPU), silicone, and combinations thereof.

In embodiments, the polymer is selected from the group consisting of polycarbonate (PC), polyethylenimine (PEI), acrylonitrile butadiene styrene (ABS), polyether ether ketone (PEEK), polyoxymethylene (POM), polybutylene terephthalate (PBT), and combinations thereof.

In embodiments, the filler is electrically conductive.

In embodiments, the filler has a surface resistance of about 10⁻⁴ Ohms or less.

In embodiments, the filler is selected from the group consisting of a metal or an alloy thereof, carbon, a carbide, a nitride, an oxide, MXene, and combinations thereof.

In embodiments, the filler is selected from the group consisting of a metal or an alloy thereof, carbon, silicon carbide, boron carbide, titanium carbide, tungsten carbide, aluminium nitride, zinc oxide, and combinations thereof.

In embodiments, the metal is a transition metal or a post-transition metal.

In embodiments, the metal is selected from silver, gold, copper, nickel, iron, zinc, aluminium, and combinations thereof.

In embodiments, the carbon is in the form of graphite, graphene, graphene oxide, carbon black, carbon nanotubes, or combinations thereof.

In embodiments, the carbon is at least partially coated with a metal, such as nickel.

In embodiments, the aerosol provision device further comprises a susceptor, wherein the susceptor defines the receptacle.

In embodiments, the aerosol provision device further comprises an outer cover forming at least a portion of an outer surface of the aerosol provision device, wherein an outer surface of the outer cover is positioned away from an outer surface of the susceptor. In one aspect, in use a temperature of the outer surface remains below about 70° C., 60° C., 55° C. or about 48° C.

In embodiments, the inductor coil is a substantially helical coil extending around the receptacle, and wherein the electromagnetic shield member extends at least partially around the inductor coil.

In embodiments, the inductor coil is a substantially planar coil defining a first substantially planar surface on a first side of the inductor coil, a second substantially planar surface on a second side of the inductor coil opposite the first side, and a perimeter surface connecting the first and second substantially planar surfaces; and the electromagnetic shield member at least partially covers one or more of the first substantially planar surface, the second substantially planar surface, and the perimeter surface.

According to another aspect of the present disclosure, there is provided an aerosol provision system comprising: an aerosol provision device as described above; and an article comprising aerosol generating material. The article may be dimensioned to be at least partially received within the heater assembly.

The device may be a tobacco heating device, also known as a heat-not-burn device.

According to another aspect of the present disclosure, there is provided an electromagnetic shield member for an aerosol provision device, wherein the electromagnetic shield member comprises a polymeric composition as defined herein. In embodiments, the polymeric composition is configured to absorb and/or reflect electromagnetic radiation.

According to another aspect of the present disclosure, there is provided the use of a polymeric composition as an electromagnetic shield member for an aerosol provision device, wherein the polymeric composition is as defined herein. In embodiments, the polymeric composition is configured to absorb and/or reflect electromagnetic radiation.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device.

FIG. 2 shows a front view of the aerosol provision device of FIG. 1 with an outer cover removed.

FIG. 3 shows a cross-sectional view of the aerosol provision device of FIG. 1.

FIG. 4 shows an exploded view of the aerosol provision device of FIG. 2.

FIG. 5A shows a cross-sectional view of a heating assembly within an aerosol provision device.

FIG. 5B shows a close-up view of a portion of the heating assembly of FIG. 5A.

FIG. 6 shows a perspective view of an example electromagnetic shield member arranged within an aerosol provision device.

FIG. 7 shows a diagrammatic representation of a cross section of an example electromagnetic shield member arranged within an aerosol provision device.

FIG. 8A is an example of a cross-section of a schematic representation of an aerosol provision system comprising an aerosol provision device and an aerosol generating article, the device comprising a plurality of substantially planar inductor coils and the article comprising a plurality of portions of aerosol generating material and corresponding susceptor portions; FIGS. 8B to 8D are a variety of views from different angles of the aerosol provision article of FIG. 8A.

FIGS. 9A and 9B show two different examples of a substantially planar inductor coil having a trapezoid shape.

FIG. 10A is a schematic representation of an aerosol provision system comprising an aerosol provision device and an aerosol generating article, the device comprising a single induction heating element and a movement mechanism, and the article comprising a plurality of portions of aerosol generating material; whereas FIGS. 10B and 10C are a couple of perspective views of parts of an aerosol provision system comprising an aerosol provision device and an aerosol generating article, wherein the aerosol provision device comprises a rotating device configured to rotate, about a rotation axis, the aerosol generating article relative to a heating element of the aerosol provision device.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. The article may also be referred to as a “consumable”.

A first aspect of the present disclosure defines an aerosol provision device with a receptacle configured to receive aerosol generating material, which is heatable by a susceptor. The receptacle may be, for example, defined by the susceptor such that the susceptor receives the aerosol generating material. For example, the susceptor may be substantially tubular (i.e. hollow) and can receive the aerosol generating material therein. In one example, the aerosol generating material is tubular or cylindrical in nature, and may be known as a “tobacco stick”, for example, the aerosol generating material may comprise plant-based material, such as tobacco, formed in a specific shape which is then coated, or wrapped in one or more other materials, such as paper or foil. Alternatively, the susceptor may not be a component of the device, but is attached to, or contained within the article introduced into the device.

The receptacle may define a heater chamber configured to receive aerosol generating material.

The susceptor can be heated by penetrating the susceptor with a varying magnetic field, produced by at least one inductor coil. The heated susceptor in turn heats the aerosol generating material located within the susceptor. The device therefore further comprises an inductor coil which at least partially covers the receptacle/susceptor. For example, the inductor coil may extend around the receptacle/susceptor.

To shield electrical components of the device (and other nearby electrical devices) from the electromagnetic radiation generated by the inductor coil(s), the device comprises an electromagnetic shield member, which acts to reflect and/or absorb electromagnetic radiation, such as the electromagnetic radiation generated by the inductor coil(s), and hence mitigates the effects of the electromagnetic radiation. The electromagnetic shield member used in the invention comprises an electromagnetically shielding polymeric composition.

In the first aspect, the electromagnetic shield member at least partially covers the inductor coil. In one aspect, the electromagnetic shield member extends at least partially around the inductor coil. In one aspect, the electromagnetic shield member is in contact with the inductor coil.

Previously, a ferrite material has been used as the electromagnetic shield member in an aerosol provision device. However, this necessitates the use of an adhesive layer to attach the ferrite material to the device. For example, the ferrite material can be included in the form of a tape comprising an adhesive and powdered ferrite. However, this tape is not generally flexible, and so cannot easily be formed into intricate shapes or designs. For example, the tape can easily crack when bent.

Furthermore, current ferrite materials are generally used in the form of a compressed powder which is held in place by an adhesive which can degrade over time. Such degradation can make the electromagnetic shielding less effective and/or giving rise to unwanted loose ferrite material within the device.

It has now been found that a polymeric composition can be used in place of the ferrite material within an aerosol provision device. One advantage of using a polymeric composition in an aerosol provision device is that the polymeric composition can be molded, making construction of the overall device easier and allowing for the manufacture of more complex shapes than can be formed with the previously-used ferrite tape.

In addition, the polymeric composition can provide structural strength or integrity to the device, which is not achieved through the use of a ferrite tape. As such, the polymeric composition which forms the electromagnetic shield member can also act as a structural or integral part of the device per se. This may allow for the polymeric composition to fulfil multiple functions within the device.

Furthermore, by using a plastic in place of the ferrite, the use of an adhesive can be avoided, making the device easier to construct as well as being more stable over the lifetime of the device. Other advantages of using plastics rather than ferrite material may include lower cost, lower weight, and/or lack of corrosion.

The polymeric composition used in the electromagnetic shield member of the present invention is capable of attenuating electromagnetic radiation. In particular, the polymeric composition can absorb and/or reflect electromagnetic radiation. Put another way, the polymeric composition is configured to absorb and/or reflect electromagnetic radiation.

This prevents or reduces the strength of the electromagnetic radiation passing through the polymeric composition.

In one aspect, the electromagnetic shield member used in the present invention does not contain any adhesive. In one aspect, the electromagnetic shield member is in direct contact with the inductor coil (i.e. without any adhesive between the coil and the electromagnetic shield member).

In one aspect, the electromagnetic shield member consists of polymeric composition capable of or configured to absorb and/or reflect electromagnetic radiation.

The polymeric composition generally comprises (i) a polymer and (ii) filler which is capable of absorbing and/or reflecting electromagnetic radiation.

The polymeric composition may comprise any amount of filler, such as from about 1 wt. % to about 99 wt. %, from about 10 wt. % to about 90 wt. %, or from about 25 wt. % to about 75 wt. %.

The polymeric composition may comprise any amount of polymer, such as from about 1 wt. % to about 99 wt. %, from about 10 wt. % to about 90 wt. %, or from about 25 wt. % to about 75 wt. %.

The weight ratio of polymer to filler may range from about 1:10 to about 10:1, such as from about 1:5 to about 5:1 or from about 1:2 to about 2:1.

In one aspect, the polymeric composition may include one or more additional fillers, such as colorants.

In one aspect, the polymeric composition consists essentially of polymer, the filler described herein, and optionally one or more additional fillers. In one aspect, the electromagnetic shield member consists essentially of polymer, the filler described herein, and optionally one or more additional fillers.

In one aspect, the polymeric composition consists of polymer, the filler described herein, and optionally one or more additional fillers. In one aspect, the electromagnetic shield member consists of polymer, the filler described herein, and optionally one or more additional fillers.

The polymer may be any polymer suitable for use in an aerosol generating device, such as an elastomer or a thermoplastic polymer. The thermoplastic polymer may be amorphous or semi-crystalline.

In one aspect, the polymer is selected from the group consisting of polycarbonate (PC), polyethylenimine (PEI), acrylonitrile butadiene styrene (ABS), polystyrene (PS), polyvinyl chloride (PVC), PVC alloys, cyclic olefin copolymer (COC), poly(methyl methacrylate) (PMMA), polypropylene carbonate (PPC), polyether ether ketone (PEEK), polybutylene terephthalate (PBT), polyethylene terephthalate (PET), polyoxymethylene (POM), nylon), polyethylene (PE), polypropylene (PP), thermoplastic polyurethane (TPU), silicone, and combinations thereof.

The polyethylene may be ultra-high-molecular-weight polyethylene (UHMWPE), high-density polyethylene (HDPE), or low-density polyethylene (LDPE).

In one aspect, the polymer is selected from the group consisting of polycarbonate (PC), polyethylenimine (PEI), acrylonitrile butadiene styrene (ABS), polyether ether ketone (PEEK), polyoxymethylene (POM), polybutylene terephthalate (PBT), and combinations thereof.

In one aspect, the polymer is selected from the group consisting of polyethylenimine (PEI), polybutylene terephthalate (PBT), and combinations thereof.

The filler is generally capable of reflecting and/or absorbing electromagnetic radiation. Thus, it is the filler rather than the polymer which generally provides the polymeric composition with the desired properties, namely being capable of absorbing and/or reflecting electromagnetic radiation.

In one aspect, the filler is selected from the group consisting of a metal or an alloy thereof, carbon, a carbide, a nitride, an oxide, MXene, and combinations thereof. One or more than one different fillers may be used. In one aspect, only one filler is used.

Any metal which is a solid at room temperature may be used as a filler in the present invention. For example, the metal may be a transition metal or post-transition metal. As used herein, the term “post-transition metal” includes, for example, aluminium gallium, lead, tin, thallium, indium and bismuth.

In one aspect, the metal is selected from silver, gold, copper, nickel, iron, zinc, aluminium, and combinations thereof. Any metallic alloy may also be used, such as any transition metal or post-transition metal alloy. One example of a suitable alloy is steel, such as a ferritic steel.

The carbon may be in the form of graphite, graphene, graphene oxide, carbon black, carbon nanotubes, and combinations thereof. The carbon may also be at least partially coated with a metal. For example, one suitable filler is nickel plated carbon powder.

Suitable carbides include, for example, silicon carbide, boron carbide, titanium carbide, and tungsten carbide.

Suitable nitrides include, for example, aluminium nitride.

Suitable oxides include, for example, zinc oxide.

The filler may be in the form of flakes, powder, and/or fibers.

The filler may have any suitable size or dimensions. For example, in one aspect the filler has an average longest dimension of from about 1 to about 1000 nm. In one aspect the filler is a nano-scale or micro-scale filler.

In one aspect, the filler is electrically conductive. Thus, in one aspect the polymeric composition comprises (i) a polymer and (ii) electrically conductive filler.

In one aspect the polymeric composition consists essentially of (i) a polymer and (ii) electrically conductive filler.

In one aspect the polymeric composition consists of (i) a polymer and (ii) electrically conductive filler.

In one aspect, the filler has a surface resistance of about 10⁻⁴ Ohms (sometimes called Ohms/sq or Q/sq) or less. The surface resistance may be measured in accordance with MIL-DTL-83528.

Suitable polymeric compositions for forming the electromagnetic shield member are commercially available (for example from RTP and Parker Chomerics), and could also be formulated by the skilled person, for example using the polymers and fillers described above. Suitable commercially available polymeric compositions include Premier™ PBT-225 and Premier™ PEI-140 from Parker Chomerics,

In one aspect, the polymeric composition has a shielding effectiveness of at least about 20 dB, 30 dB, 40 dB, 50 dB or 60 dB, when measured at 30 MHz. The maximum shielding effectiveness may be about 90 dB, about 80 dB, or about 70 dB, when measured at 30 MHz. Thus, in one aspect the polymeric composition has a shielding effectiveness of from about 20 to about 90 dB, such as about 30 to about 80 dB, or about 40 to about 70 dB, when measured at 30 MHz.

Alternatively or additionally, the polymeric composition has an average shielding effectiveness of at least about 10 dB, 20 dB, 30 dB, 40 dB, 50 dB or 60 dB, when measured from 30 to 1,500 MHz. The maximum average shielding effectiveness may be about 90 dB, about 80 dB, or about 70 dB, when measured from 30 to 1,500 MHz. Thus, in one aspect the polymeric composition has an average shielding effectiveness of from about 10 to about 90 dB, such as about 30 to about 80 dB, or about 40 to about 70 dB, when measured from 30 to 1,500 MHz.

In one aspect, the polymeric composition has a shielding effectiveness of at least about 10 dB, 20 dB, 30 dB, 40 dB, 50 dB or 60 dB, when measured at 150 kHz. The maximum shielding effectiveness may be about 90 dB, about 80 dB, or about 70 dB, when measured at 150 kHz. Thus, in one aspect the polymeric composition has a shielding effectiveness of from about 10 to about 90 dB, such as about 30 to about 80 dB, or about 40 to about 70 dB, when measured at 150 kHz.

Alternatively or additionally, the polymeric composition has an average shielding effectiveness of at least about 10 dB, 20 dB, 30 dB, 40 dB, 50 dB or 60 dB, when measured from 0 to 13.56 MHz. The maximum average shielding effectiveness may be about 90 dB, about 80 dB, or about 70 dB, when measured from 0 to 13.56 MHz. Thus, in one aspect the polymeric composition has an average shielding effectiveness of from about 10 to about 90 dB, such as about 30 to about 80 dB, or about 40 to about 70 dB, when measured from 0 to 13.56 MHz.

In each case, the shielding effectiveness is measured in accordance with ASTM D4935-18.

Generally, the total amount of shielding effectiveness of the electromagnetic shield member will be equal to the reflective and absorptive losses. In general, the greater the conductivity, permeability, thickness and frequency, the greater the attenuation of electromagnetic radiation due to absorption; and the greater the conductivity and the lower the frequency, the greater the amount of electromagnetic radiation which is reflected.

In one aspect, the polymeric composition has a surface resistance of about 10⁵ Ohm or less, such as about 10⁴ Ohm or less, about 100 Ohm or less or about 10 Ohm or less. The polymeric composition may have a surface resistance of about 0.01 Ohm or more, such as from about 0.01 to about 10 Ohm or from about 0.03 to about 5 Ohm.

In one aspect, the polymeric composition has an average thickness of from about 0.10 to about 2 mm, such as from about 0.15 to about 1.5 mm or about 0.20 to about 0.5 mm.

In one aspect, the electromagnetic shield member has a thickness of from about 0.10 to about 2 mm, such as from about 0.15 to about 1.5 mm or about 0.20 to about 0.5 mm.

In some examples, the device further comprises a temperature sensor in contact with the inductor coil to measure a temperature of the inductor coil. When the electromagnetic shield member is in contact with the inductor coil, the temperature sensor may more accurately measure the temperature of the inductor coil.

The inductor coil may extend around the susceptor/receptacle in a helical fashion. The susceptor may define a longitudinal axis, such that the electromagnetic shield member extends around the longitudinal axis in an azimuthal direction, therefore forming a full or partial tube-like structure.

The aerosol provision device may comprise two or more inductor coils. For example, a first inductor coil may extend around a first portion the receptacle/susceptor, and a second inductor coil may extend around a second portion of the receptacle/susceptor. The first and second inductor coils may be arranged adjacent to each other in a direction along the longitudinal axis of the receptacle/susceptor. In such a device, the electromagnetic shield member may be in contact with, and extend at least partially around, the first and second inductor coils.

In some examples the aerosol provision device comprises the susceptor, and the susceptor defines the receptacle.

In some examples, the device comprises two or more inductor coils arranged along the length of the susceptor and between each adjacent inductor coil the device comprises a radially extending wall, such as a washer.

In some examples, the radially extending wall can extend at least partially around the susceptor to separate each inductor coil. It has been found that such radially extending walls act to decouple the induction coils meaning each coil acts independently, i.e. there are no or lower induced effects in a neighbouring non-operated coil. The magnetic flux from each inductor coil can therefore be more localized. In some examples, the walls can help channel/focus energy into the article at location of the wall, which can mean that the total number of coils can be reduced. The radially extending walls can act as a collar around the susceptor. The radially extending wall may be coaxial with the susceptor. Radially extending may mean that the wall extends in a direction parallel to a radius of the tubular susceptor.

In some examples, the wall is attached to (i.e. in contact with) the susceptor. For example, it may extend from the susceptor to the inductor coils. In other examples, the wall is not attached to the susceptor. For example, it may extend from the outer surface of the insulating member. In one example, the walls and susceptor are made from the same material. In a particular example, the walls comprise ferrite.

Accordingly, in one example, there is provided an aerosol provision device, comprising a susceptor, a first inductor coil extending around a first region of the susceptor and a second inductor coil extending around a second region of the susceptor, wherein the device further comprises a radially extending electromagnetic shield member arranged between the first inductor coil and the second inductor coil. The electromagnetic shield member and device may comprise any of the features described above and herein.

The electromagnetic shield member arrangement may create a thermal barrier between the hot susceptor and the outer casing/housing of the device. In examples, an outer cover of the device is maintained below about 75° C., such as below about 70° C., 60° C., 55° C. or 48° C. In other examples, the outer cover of the device is maintained below 45° C. or below 43° C. during use. In some examples, the outer cover of the device is maintained below 43° C. for at least 3 or 4 back-to-back heating sessions. A session includes heating the article for a period of between about 3 minutes to about 4 minutes until the aerosol generating material is spent. The use of an electromagnetic shield member on the inductor coils may reduce the surface temperature of the outer cover by up to 3° C. Additional, or alternative insulation features, such as the use of an air gap between the susceptor and insulating member can also maintain the temperature of the outer cover below about 48° C.

Accordingly, in another aspect, an aerosol provision device comprises an inductor coil and a susceptor configured to heat aerosol generating material, wherein the inductor coil is arranged to heat the susceptor. The device comprises an outer cover forming at least a portion of an outer surface of the aerosol provision device, wherein an outer surface of the outer cover is positioned away from an outer surface of the susceptor. In use, a temperature of the outer surface remains below about 75° C., such as below about 70° C., 60° C., 55° C. or about 48° C.

Accordingly, the device remains below about 75° C., such as below about 70° C., 60° C., 55° C. or about 48° C. for at least one heating session. In some examples, in use, the temperature of the outer surface remains below about 43° C.

In one aspect, in use, the temperature of the outer surface remains below about 43° C. for a period of at least three heating sessions, wherein a heating session lasts for at least 180 seconds. Accordingly, in use, the temperature of the outer surface remains below about 43° C. for a period of at least 540 seconds. A heating session means that the susceptor is being continuously heated during this time. In some examples, the average temperature of the susceptor during a heating session is between about 240° C. and about 300° C. Preferably the heating sessions are performed back-to-back (i.e. begin within less than about 30 seconds, or less than about 20 seconds, or less than about 10 seconds of each other).

In another aspect, in use, the temperature of the outer surface remains below about 43° C. for a period of at least four heating sessions.

In some examples, a heating session lasts for at least 210 seconds.

The device may further comprise an electromagnetic shield member in contact with, and extending at least partially around, the coil. The electromagnetic shield member may comprise any or all of the features described above in relation to the first and second aspects.

The device may further comprise an insulating member at least partially covering or extending around the susceptor. The insulating member can help maintain the temperature of the outer surface below about 48° C. In some examples, the insulating member is positioned away from the susceptor to provide an air gap around the susceptor. The air gap provides an additional thermal barrier.

The insulating member may have a thickness of between about 0.25 mm and about 1 mm. The insulating member (and any air gap between the susceptor and insulating member) helps insulate the outer cover from the heated susceptor. The insulating member may be constructed from any insulating material, such as plastic for example. In a particular example, the insulating member is constructed from polyether ether ketone (PEEK). PEEK has good insulating properties and is well suited for use in an aerosol provision device.

In another example, the insulating member may comprise mica or mica-glass ceramic. These materials have good insulation properties.

The insulating member may have a thermal conductivity of less than about 0.5 W/mK, or less than about 0.4 W/mK. For example, the thermal conductivity may be about 0.3 W/mK. PEEK has a thermal conductivity of about 0.32 W/mK.

The insulating member may have a melting point of greater than about 320° C., such as greater than about 300° C., or greater than about 340° C. PEEK has a melting point of 343° C. Insulating members with such melting points ensure that the insulating member remains rigid/solid when the susceptor is heated.

The inner surface of the outer cover may be positioned away from the outer surface of the insulating member by a distance of greater than 0 mm and less than about 3 mm. A separation distance of this size may provide enough insulation to ensure that the outer cover does not get too hot. Air may be located between the outer surface of the insulating member and the outer cover. In one aspect, the inner surface of the outer cover is not in direct contact with the insulating member. This can avoid a thermally conductive path between the inner surface of the outer cover and the insulating member.

In use, the inductor coil may be configured to heat the susceptor to a temperature of between about 200 and about 300° C. In use, the inductor coil may be configured to heat the susceptor to a temperature of about 350° C.

The inductor coil may be substantially helical. The inductor coil may be a spiral coil. For example, the inductor coil may be formed from wire, such as Litz wire, which is wound helically around the coil support.

The inductor coil, the susceptor and the insulating member may be coaxial.

In some examples, in use, the inductor coil is configured to heat the susceptor to a temperature of between about 200° C. and about 350° C., such as between about 240° C. and about 300° C., or between about 250° C. and about 280° C.

An inner surface of the outer cover may be positioned away from an outer surface of the susceptor by a distance of between about 4 mm and about 6 mm. This distance is the distance between the outer surface of the susceptor and the inner surface of the outer cover at its closest point. The distance may therefore be the minimum distance between the outer surface of the susceptor and the inner surface of the outer cover. In one example, the distance may be measured between the susceptor and a side surface of the device. It has been found that when the outer is cover is positioned away from the susceptor by this distance, the outer cover is insulated enough from the heated susceptor to keep the surface temperature below 48° C., while reducing the size and weight of the device. Thus, distances within this range represents a good balance between insulation properties and device dimensions.

In one example, the inner surface of the outer cover is positioned away from the outer surface of the susceptor by a distance of between about 5 mm and about 6 mm. Preferably, the inner surface of the outer cover is positioned away from the outer surface of the susceptor by a distance of between about 5 mm and about 5.5 mm, such as between about 5.3 mm and about 5.4 mm. A spacing within this range of distances provides better insulation while also ensuring that the device remains small and lightweight. In a particular example, the spacing is 5.3 mm.

The device may further comprise at least one insulation layer positioned between the outer cover and the susceptor. The insulation layer insulates the outer cover from the susceptor.

An insulation layer may be located in any or all of the following locations: (i) between the susceptor and insulating member, (ii) between the insulating member and the coil, (iii) between the coil and outer cover. In (ii), the insulating member may have a smaller outer diameter to accommodate the insulation layer. Additionally, or alternatively, the coil may have a larger inner diameter to accommodate the insulation layer. The insulation layer may comprise multiple layers of materials.

The insulation layer may be provided by any of the following materials (i) air (which has a thermal conductivity of about 0.02 W/mK), (ii) a polyimide aerogel such as AeroZero® (which has a thermal conductivity of between about 0.03 W/mK and about 0.04 W/mK), (iii) polyether ether ketone (PEEK) (which may have a thermal conductivity of about 0.25 W/mK in some examples), (iv) ceramic cloth (which has a specific heat of about 1.13 kJ/kgK), (v) thermal putty.

In some examples, the outer surface of the outer cover comprises a coating. The coating and/or outer cover may have a high thermal conductivity. For example, the conductivity may be greater than about 200 W/mK. A relatively high thermal conductivity ensures that heat disperses throughout the outer cover, which in turn is lost to the atmosphere, thereby cooling the device. In a particular example, the coating is soft touch paint.

In some examples, the device comprises a temperature sensor arranged to measure a temperature of the battery. The device may comprise a controller that is configured to cause the device to stop heating when the temperature of the battery is equal to or greater than a threshold temperature. The threshold temperature may be about 45° C. or 50° C., for example.

An inner surface of the outer cover may be positioned away from an outer surface of the susceptor by a distance of between about 4 mm and about 6 mm. This distance is the distance between the outer surface of the susceptor and the inner surface of the outer cover at its closest point. The distance may therefore be the minimum distance between the outer surface of the susceptor and the inner surface of the outer cover. In one example, the distance may be measured between the susceptor and a side surface of the device. It has been found that when the outer is cover is positioned away from the susceptor by this distance, the outer cover is insulated enough from the heated susceptor to avoid discomfort or injury to a user, while reducing the size and weight of the device. Thus, distances within this range represents a good balance between insulation properties and device dimensions.

The outer cover may also be known as an outer casing. The outer casing may fully surround the device, or may extend partially around the device. In one example, the inner surface of the outer cover is positioned away from the outer surface of the susceptor by a distance of between about 5 mm and about 6 mm. Preferably, the inner surface of the outer cover is positioned away from the outer surface of the susceptor by a distance of between about 5 mm and about 5.5 mm, such as between about 5.3 mm and about 5.4 mm. A spacing within this range of distances provides better insulation while also ensuring that the device remains small and lightweight. In a particular example, the spacing is 5.3 mm.

In some examples, in use, the coil is configured to heat the susceptor to a temperature of between about 240° C. and about 300° C., such as between about 250° C. and about 280° C.

When the outer cover is spaced apart from the susceptor by at least this distance, the temperature of the outer cover remains at a safe level, such as less than about 48° C., or less than about 43° C.

In some examples, an air gap is formed between the coil and the outer cover. The air gap provides insulation.

The inner surface of the outer cover may be positioned away from an outer surface of the coil by a distance of between about 0.2 mm and about 1 mm. In some examples the coil itself may heat up as it is used to induce a magnetic field, for example from resistive heating due to the current passing through it to induce the magnetic field. Providing a spacing between the coil and outer cover ensures that the heated coil is insulated from the outer cover. In some examples, an electromagnetic shield member is located between the inner surface of the outer cover and the coil. This additionally helps insulate the inner surface of the outer cover.

In one example, the coil comprises litz wire, and the litz wire has a circular shaped cross section. In such an example, the inner surface of the outer cover is positioned away from the outer surface of the coil by a distance of between about 0.2 mm and about 0.5 mm, or between about 0.2 mm and about 0.3 mm such as about 0.25 mm.

In one example, the coil comprises litz wire, and the litz wire has a rectangular shaped cross section. In such an example, the inner surface of the outer cover is positioned away from an outer surface of the coil by a distance of between about 0.5 mm and about 1 mm, or between about 0.8 mm and about 1 mm, such as about 0.9 mm. A litz wire with a circular cross section can be arranged closer to the outer cover than a litz wire with a rectangular cross section because the circular cross section wire has a smaller surface area exposed towards the outer cover.

The inner surface of the coil may be positioned away from the outer surface of the susceptor by a distance of between about 3 mm and about 4 mm.

The outer cover may comprise aluminium. Aluminium has good heat dissipation properties. The outer cover may have a thermal conductivity of between about 200 W/mK and about 220 W/mK. For example, aluminium has a thermal conductivity of around 209 W/mK. Thus, the outer cover may have a relatively high thermal conductivity to ensure that it heat disperses throughout the outer cover, which in turn is lost to the atmosphere, thereby cooling the device.

The outer cover may have a thickness of between about 0.75 mm and about 2 mm. The outer cover can therefore also act as an insulating barrier. These thicknesses provide a good balance between providing good insulation and reducing the size and weight of the device.

Preferably the outer cover has a thickness of between about 0.75 mm and about 1.25 mm, such as about 1 mm.

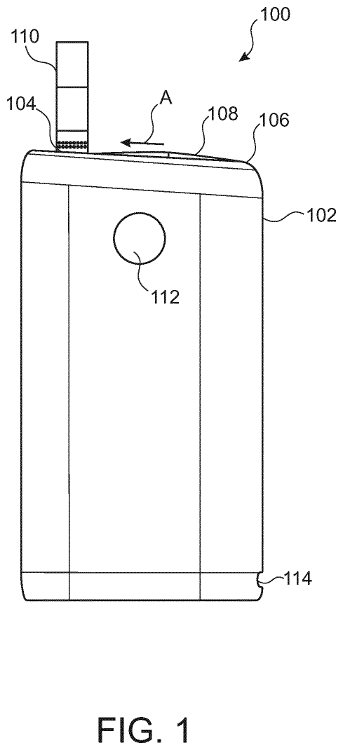

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100. The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the lid 108 may move into a closed configuration. For example, a user may cause the lid 108 to slide in the direction of arrow “A”.

The device 100 may also include a user-operable control element 112, such as a button or switch, which operates the device 100 when pressed. For example, a user may turn on the device 100 by operating the switch 112.

The device 100 may also comprise an electrical component, such as a socket/port 114, which can receive a cable to charge a battery of the device 100. For example, the socket 114 may be a charging port, such as a USB charging port.

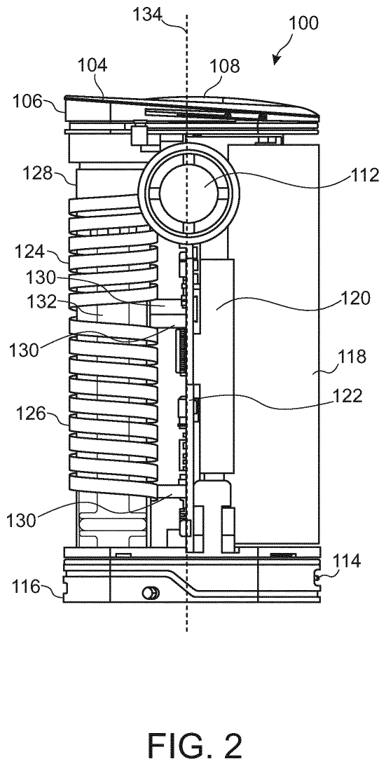

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100. The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery, (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks. In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular. The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 to not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This is can be useful when the inductor coils are active at different times. For example, initially, the first inductor coil 124 may be operating to heat a first section of the article 110, and at a later time, the second inductor coil 126 may be operating to heat a second section of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from poly ether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

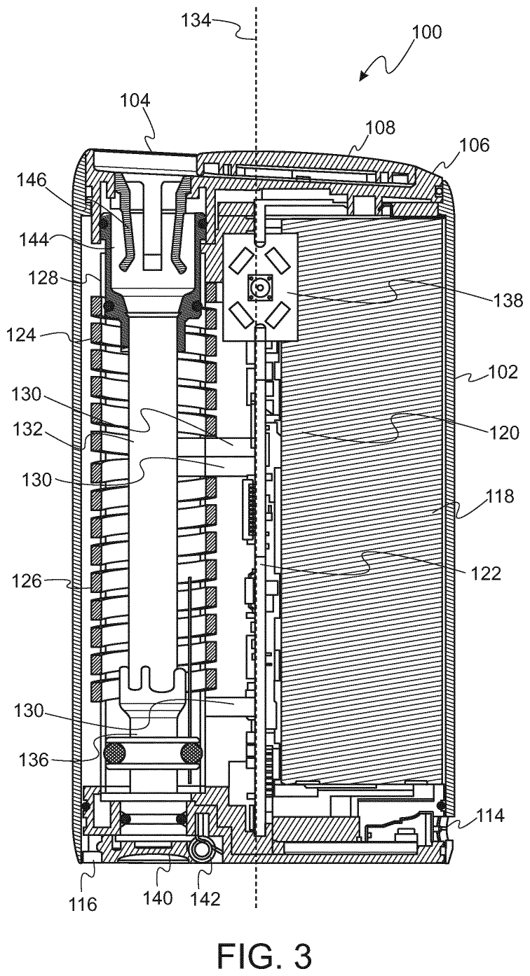

FIG. 3 shows a side view of device 100 in partial cross-section. The outer cover 102 is present in this example. The rectangular cross-sectional shape of the first and second inductor coils 124, 126 is more clearly visible. The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

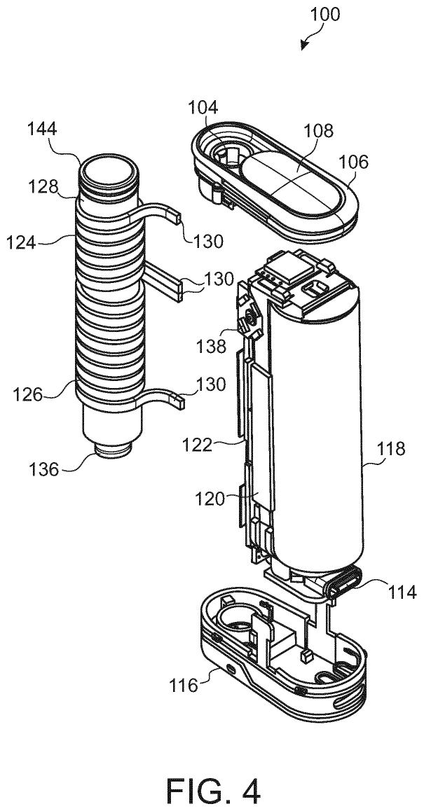

FIG. 4 is an exploded view of the device 100 of FIG. 1, with the outer cover 102 omitted.

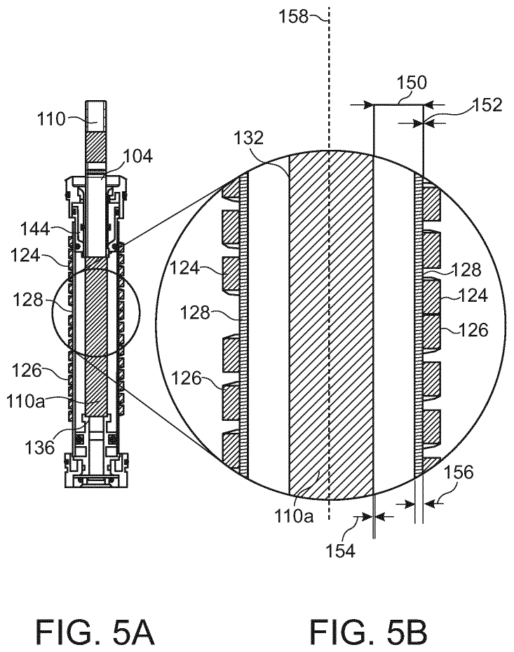

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, 0.25 mm to 1 mm, or about 0.5 mm.

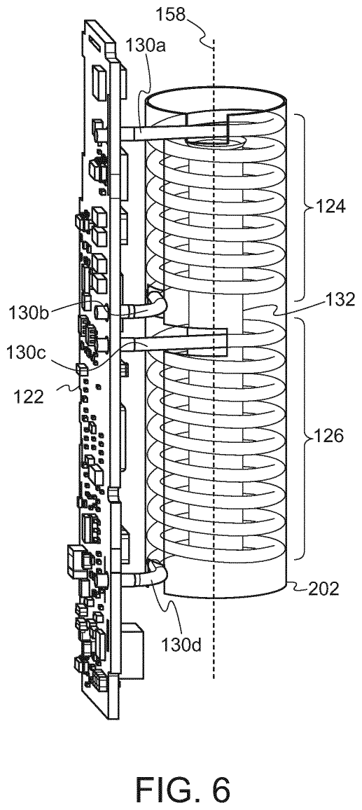

FIG. 6 depicts a perspective view of the printed circuit board (PCB) 122, the susceptor 132, the first inductor coil 124 and the second inductor coil 126. In this example the first and second inductor coils 124, 126 are made from wire having a circular cross-section. First and second ends 130a, 130b of the first inductor coil 124, are connected to the PCB 122. Similarly, first and second ends 130c, 130d of the second inductor coil 126 are connected to the PCB 122. In some examples, there may only be one inductor coil present.

Extending around the first and second inductor coils 124, 126 is an electromagnetic shield member 202. This electromagnetic shield member 202 is in contact with, and surrounds the first and second inductor coils 124, 126 to shield other components of the device 100 and/or other objects from electromagnetic radiation generated within the susceptor and/or first and second inductor coils 124, 126. The electromagnetic shield member 202 is illustrated as being transparent, to clearly show the inductor coils 124, 126 and the susceptor 132 arranged within the electromagnetic shield member 202.

Although FIG. 6 depicts the electromagnetic shield member 202 as being in contact with the inductor coils, as would be immediately apparent to the skilled person the electromagnetic shield member 202 may be located anywhere in the device. For example, there may be an insulating member or air gap between the electromagnetic shield member 202 and the inductor coils. In one aspect, the electromagnetic shield member 202 may be located directly adjacent to an outer surface of the device (on the inside of the device). In another aspect, the electromagnetic shield member 202 may form at least part of an outer surface of the device.

The susceptor 132 receives an article 110 and therefore defines a receptacle configured to receive aerosol generating material. In other examples (not shown) the susceptor 132 is part of the article 110, rather than the device 100, and so other components may define the receptacle. The receptacle/susceptor 132 defines an axis 158, such as a longitudinal axis 158, around which the electromagnetic shield member 202 is wrapped.

As discussed above, the electromagnetic shield member 202 comprises one or more polymeric components, which acts as a shield against the electromagnetic radiation.

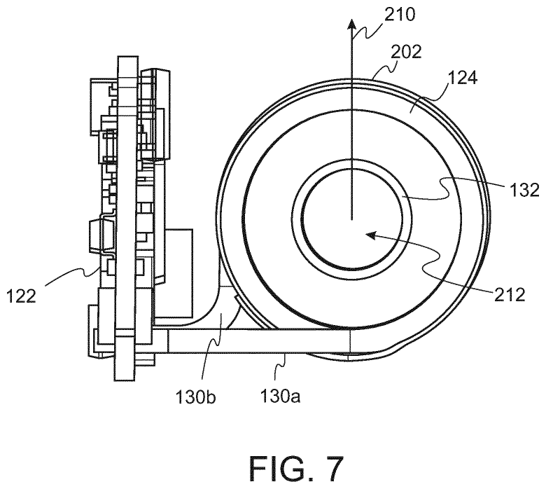

As shown in FIGS. 6 and 7, the first and second ends 130a, 130b of the first inductor coil 124 may pass through notches/openings/apertures formed in the electromagnetic shield member 202. These notches may allow the electromagnetic shield member 202 to more closely conform to the first and second inductor coils 124, 126.

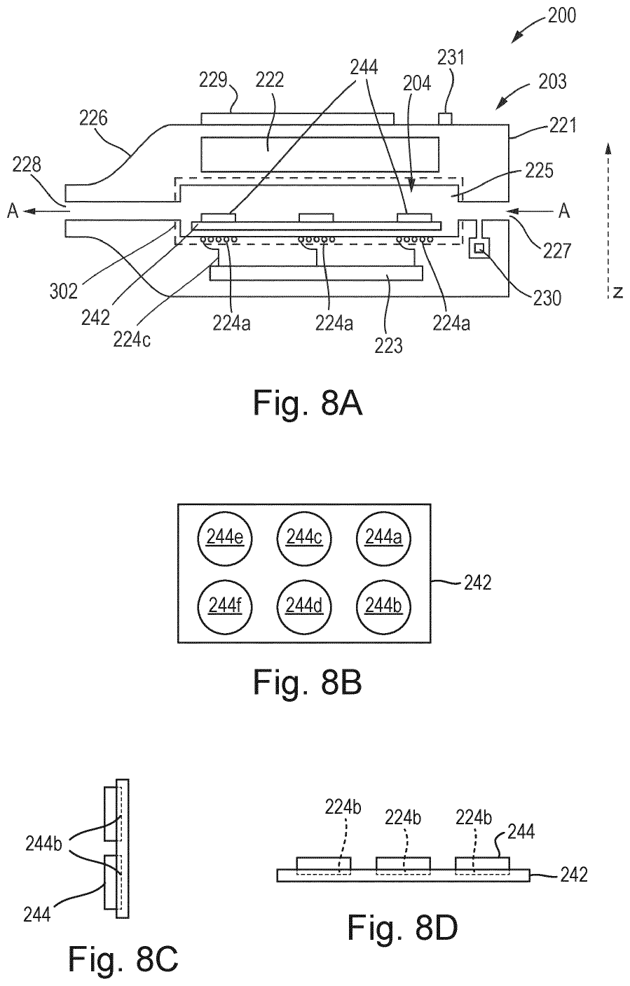

FIG. 8A is a cross-sectional view through a schematic representation of an aerosol provision system 200 in accordance with another embodiment of the disclosure. The aerosol provision system 200 comprises two main components, namely an aerosol provision device 203 and an aerosol generating article 204.

The aerosol provision device 203 comprises an outer housing 221, a power source 222, control circuitry 223, a plurality of aerosol generating components 224, a receptacle or aerosol forming chamber 225, a mouthpiece end 226, an air inlet 227, an air outlet 228, a touch-sensitive panel 229, an inhalation sensor 230, and an end of use indicator 231.

The outer housing 221 may be formed from any suitable material, for example a plastics material. In one aspect, the outer housing is formed from the same polymeric composition disclosed herein. That is, the outer house may form the electromagnetic shield member 202.

The outer housing 221 is arranged such that the power source 222, control circuitry 223, aerosol generating components 224, receptacle 225 and inhalation sensor 230 are located within the outer housing 221. The outer housing 221 also defines the air inlet 227 and air outlet 228. The touch sensitive panel 229 and end of use indicator are located on the exterior of the outer housing 221.

In the described implementation, the aerosol provision device 203 further comprises a receptacle 225 which is arranged to receive an aerosol generating article 204.

The aerosol generating article 204 comprises a carrier component, aerosol generating material 244, and susceptor elements 244b, as shown in more detail in FIGS. 8B to 8D. FIG. 8B is a top-down view of the article 204, FIG. 8C is an end-on view along the longitudinal (length) axis of the article 204, and FIG. 8D is a side-on view along the width axis of the article 204.

FIGS. 8A to 8D represent an aerosol provision system 200 which uses induction to heat the aerosol generating material 244 to generate an aerosol for inhalation.

In the described implementation, the aerosol generating component 224 is formed of two parts; namely, induction heating elements such as inductor coils 224a which are located in the aerosol provision device 203 and susceptors 224b which are located in the aerosol generating article 204. In embodiments, the induction heating elements may comprise one or more of: (i) a flat spiral coil, wherein the spiral coil comprises a circular or ovular spiral, a square or rectangular spiral, a trapezoidal spiral, or a triangular spiral; (ii) a multi-layered induction arrangement wherein subsequent full or partial turns of the coil are provided on adjacent layers, optionally wherein a first layer is spaced from a second layer in a first direction and a third layer is spaced from the second layer in the opposite direction to reside in or close to the first layer such that the multi-layered induction arrangement forms a staggered structure; or (iii) a three-dimensional inductor coil, such as a regular helix or a conically shaped inductor coil, optionally with a varying helical pitch.

Accordingly, in this described implementation, each aerosol generating component 224 comprises elements that are distributed between the aerosol generating article 204 and the aerosol provision device 203.

As seen in FIGS. 8C and 8D, the carrier component 242 comprises a number of susceptors 224b which correspond in size and location to the discrete portions of aerosol generating material 244 disposed on the surface of the carrier component 242. That is, the susceptors 224b have a similar width and length to the discrete portions of aerosol generating material 244.

The susceptors are shown embedded in the carrier component 242. However, in other implementations, the susceptors 224b may be placed on the surface of the carrier component 242. In another implementation (not shown), the susceptor may be provided as a layer substantially covering the carrier component.

The aerosol provision device 203 comprises a plurality of inductor coils 224a shown schematically in FIG. 8A. The inductor coils 224a are shown adjacent the receptacle 225, and are generally flat coils arranged such that the rotational axis about which a given coil is wound extends into the receptacle 225 (e.g., parallel with the z-axis as indicated in FIG. 8A) and is broadly perpendicular to the plane of the carrier component 242 of the article 204. The exact windings are not shown in FIG. 8A and it should be appreciated that any suitable induction coil may be used.

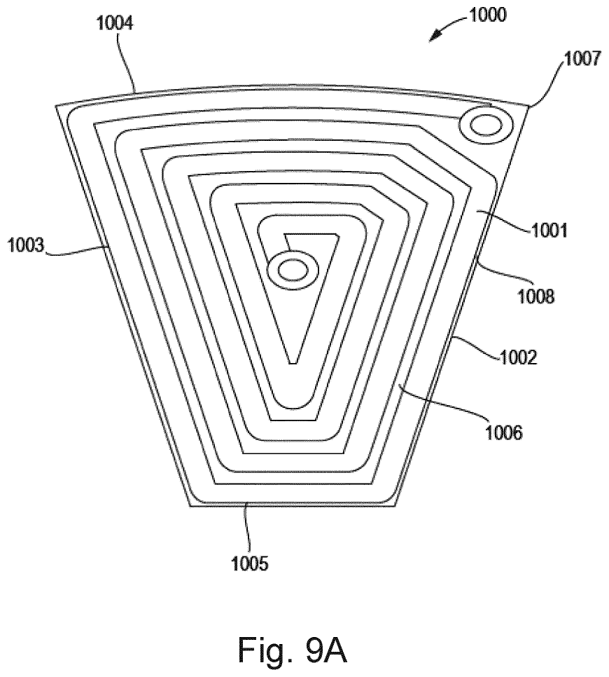

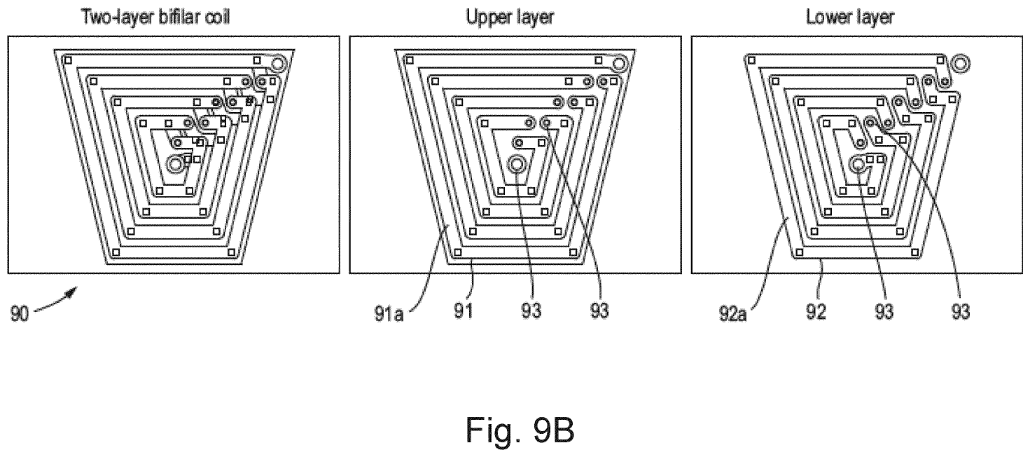

FIGS. 9A and 9B two different examples of a substantially planar or flat inductor coil.

FIG. 9A shows a trapezoid shaped inductor arrangement 1000. The trapezoid shaped inductor arrangement may comprise an electrically-conducting track 1001, for example a copper track. As show, the electrically-conducting track 1001 may form an inductor coil in a substantially trapezoidal shape, wherein the substantially trapezoidal shape comprises: a first angled side 1002; a second angled side 1003; a long side 1004; and a short side 1005 shorter in length than the long side 1004.

Referring to FIG. 9B, there is shown an embodiment of a substantially planar inductor coil comprising a layered inductor arrangement 90, wherein the layered inductor arrangement 90 is a two-layer bifilar coil inductor arrangement 90 comprising a first layer 91 and a second layer 92. The layered inductor arrangement 90 of FIG. 9B is shown as a trapezoid shaped inductor arrangement, however it will be understood that the layered inductor arrangement could have any number of shapes such as circular, square, rectangular, etc, or be irregularly shaped. The first layer 91 comprises one or more first electrically-conductive wires or tracks 91a, and the second layer 92 comprises one or more second electrically-conductive wires or tracks 92a. The first 91a and second 92a electrically-conductive wires or tracks may be concentric and substantially over-lapping when viewed from a perspective face-on to the layers, as shown in FIG. 9. One or more electrically-conductive linking portions 93 connect one or more of the first electrically-conductive wires or tracks 91a to the second electrically-conductive wires or tracks 92a. In embodiments, the layered inductor arrangement 90 may be formed in a PCB format, wherein the vertical plane can be used and adding to the already low aspect ratio (height of copper track to width) enhances further the effect. It has been found that coupling the wires or tracks vertically instead of horizontally further enhances the mutual coupling or capacitive linking of the wires, while minimising the phase shift between them.

Accordingly, in embodiments, the inductor coil is a substantially planar coil defining a first substantially planar surface on a first side of the inductor coil (e.g., with the normal to the first surface directed along the z-axis so as to face towards the receptacle 225), a second substantially planar surface on a second side of the inductor coil opposite the first side (e.g., with the normal to the second surface directed along the z-axis in the opposite direction to the normal of the first surface so as to face away from the receptacle 225), and a perimeter surface connecting the first and second substantially planar surfaces (e.g., the surface defining the sides 1002-1005 in FIG. 9A).

Referring back to FIGS. 8A-8D, covering the inductor coils 224a is an electromagnetic shield member 302 (indicated by the dashed lines). This electromagnetic shield member 302 may be in contact with, and substantially cover, the inductor coils 224a to shield other components of the device 203 and/or other objects from electromagnetic radiation generated within the susceptor and/or inductor coils 224a. For instance, the electromagnetic shield member 302 may substantially extend around the receptacle 225 so as to surround both the inductor coils 224a and the receptacle 225 with the susceptors 224b arranged therein.

However, it will be understood that other designs of the electromagnetic shield member 302 are possible, for example being in the form of a cap (not shown) corresponding to one or more of the inductor coils 224a so as to cover the second surface of the one or more inductor coils 224a facing away from the receptacle 225 and the perimeter surface of the one or more inductor coils 224a.

As discussed above, the electromagnetic shield member 302 comprises one or more components of polymeric composition, which acts as a shield against electromagnetic radiation.

The one or more ends 224c of each inductor coil 224a may pass through notches/openings/apertures formed in the electromagnetic shield member 302. These notches may allow the electromagnetic shield member 302 to more closely conform to the inductor coils 224a. Moreover, the electromagnetic shield member 302 may comprise further notches/openings/apertures such that the air flow path between air inlet 227 and air outlet 228 is unimpeded by the electromagnetic shield member 302.

Although the above has described an induction heating aerosol provision system where the inductor coils 224a and susceptors 224b are distributed between the article 204 and device 203, an induction heating aerosol provision system may be provided where the inductor coils 224a and susceptors 224b are located solely within the device 203. For example, with reference to FIGS. 8B-8C, the susceptors 224b may be provided above the inductor coils 224a and arranged such that the susceptors 224b contact the lower surface of the carrier component 242.

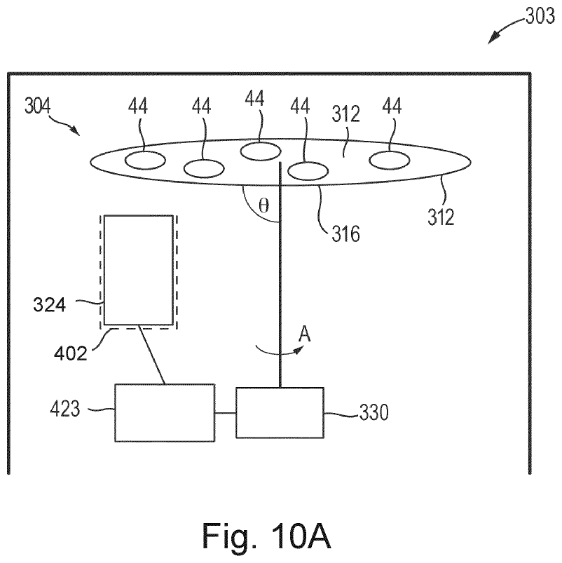

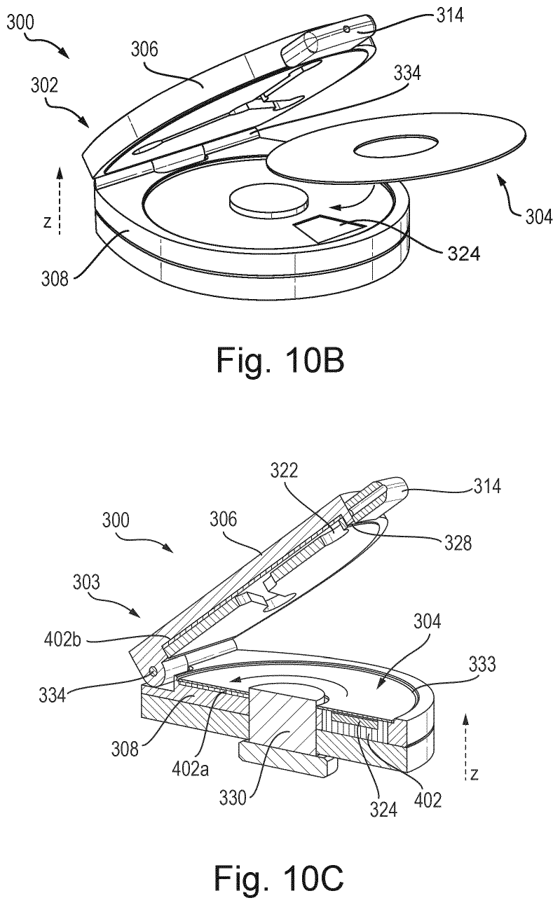

FIG. 10A illustrates a schematic view of a portion of an aerosol provision device 303. The device 303 has an article 304, which comprises aerosol generating medium, within the device 303. The combination of the device 303 and the article 304 form an aerosol provision system 300.

The article 304 has a first surface 312 which includes aerosol generating medium. In the described implementation, the article includes a carrier layer 311 (sometimes referred to herein as a carrier or a substrate supporting layer) which has a first surface on which the aerosol generating medium is disposed. In this implementation, a combination of the surface of the carrier layer 311 and of the aerosol generating material forms the first surface 312 of the article 304. In the described implementation, the aerosol generating medium may be arranged as a plurality of doses 44 of the medium. The article 304 has a second surface 316 which faces the first surface 312. The second surface 316 faces the first surface 312 and one or both of the first surface 312 and second surface 316 may be smooth or rough. In the described implementation, the second surface 316 is formed by the carrier layer 311. That is, the carrier layer 311 has a first surface and a second surface which faces the first surface, where aerosol generating material is disposed on the first surface of the carrier layer 311. The device 303 has a source of energy for supplying induction heating element 324 arranged to face the second surface 316 of the article 304. The source of energy for induction heating element 324 is an element of the aerosol provision device 303 which transfers energy from a power source, such as a battery (not shown), to the aerosol generating medium 44 to generate aerosol from the aerosol generating medium 44. In such implementations, the induction heating element 324 may include one or more inductor coils, which, when energised, causes heating within one or more susceptor elements of the article 304.

The device 303 has a movement mechanism 330 arranged to move the article 304, and in particular portions 44 (or, in some cases, doses) of aerosol generating medium. The portions 44 of aerosol generating medium are preferably rotationally movable relative to the induction heating element 324 such that portions of the aerosol generating medium are presented, in this case individually, to the heating element 324. The device 303 is arranged such that at least one dose 44 of the aerosol generating medium is rotated around an axis A at an angle θ to the second surface 316. Control circuitry 323 is configured to actuate both the induction heating element 324 and the movement mechanism 330 such that the article 304 rotates so as to align a discrete portion 44 with the heating element 324. The article 304 in this implementation is substantially flat. The carrier layer 311 of article 304 in this implementation may be formed of partially or entirely of paper or card.

In some implementations, the carrier layer 311 of the substrate may be, or may include, a metallic element that is arranged to be heated by a varying magnetic field.

The degree of heating may be affected by the distance between the metallic element and the induction coil.

The article 304 in FIG. 10A has a number (5) of doses (or portions) 44 of aerosol generating medium. In other examples, the article 304 may have more or less doses 44 of aerosol generating medium. In some examples, the article 304 may have the doses 44 of aerosol generating medium arranged in discrete doses as shown in FIG. 10A.

In other examples, the doses 44 may be in the form of a disc, which may be continuous or discontinuous in the circumferential direction of the article 304. In still other examples, the doses 44 may be in the form of an annulus, a ring or any other shape. The article 304 may or may not have a rotationally symmetrical distribution of doses 44 at the first surface 312 about the axis A. A symmetrical distribution of doses 44 would enable equivalently positioned doses (within the rotationally symmetrical distribution) to receive an equivalent heating profile from the induction heating element 324 upon rotation about the axis A, if desired.

The article 304 of the present example includes aerosol generating medium disposed on the carrier layer 311 of the article 304. However, in other implementations, the article 304 may be formed exclusively of aerosol generating medium; that is, in some implementations, the article 304 consists entirely of aerosol generating medium. In such embodiments, the one or more susceptors will be part of the device 303. Alternatively, the one or more susceptors may be embedded within the aerosol generating medium of article 304, such that article 304 consists only of the aerosol generating medium and the susceptors embedded therein. In yet other implementations, the article 304 may have a layered structure from a plurality of materials. In one example, the article 304 may have a layer formed from at least one of thermally conductive material, inductive material, permeable material or impermeable material.

The arrangement shown in FIG. 10A operates by indexing (or moving) the plurality of doses of aerosol generating material to the induction heating element 324. While this arrangement of FIG. 10A may have a slight increase in the complexity of the movement mechanism 330 to provide movement to the article 304, there are benefits to be had by virtue of there only being one induction heating element 324 required to heat a plurality of portions of aerosol generating medium. For example, the single heating element 324 in the arrangement of FIG. 10A requires only one control mechanism (such as control circuitry 323) rather than a plurality of heaters requiring a plurality of control mechanisms. As such, this arrangement can reduce the cost and control complexity in relation to the operation and control of the heating element 324.

The shape of the device 303 may be cigarette-shape (longer in one dimension than the other two) or may be other shapes. In an example, the device 303 may have a shape that is longer in two dimensions than the other one, for example like a compact-disc player or the like. Alternatively, the shape may be any shape that can suitably house the article 304, source of energy for heating element 324 and the movement mechanism 330.

Other than the single heating element 324 and movement mechanism 330 configured to rotate article 304 of FIG. 10A in place of the plurality of heating elements 224 of FIG. 8A, it will be understood that the device of FIG. 10A may comprise one or more of the other features described in relation to FIG. 8A, e.g., such as the inhalation sensor.

As shown, device 303 may include an electromagnetic shield member 402, which substantially covers the induction heating element 324 except for the side of element 324 facing the article 304 so as to not block or otherwise impede the alternating magnetic field generated by element 324 from heating the one or more susceptors in, or adjacent to, article 304. The electromagnetic shield member 402 may comprise the polymeric composition described herein.

Referring now to FIGS. 10B and 10C, there is shown an aerosol provision device 303 comprising a lid portion 306 and a base portion 308. The aerosol provision device 303 also comprises a securing mechanism (not shown) configured to engage the lid portion 306 with the base portion 308. Once engaged, the lid portion 306 and the bases portion 308 hold in position therebetween, in use, an aerosol generating article 304 so as to prevent relative movement of the aerosol generating article 304.

In some embodiments, the aerosol provision device 302 comprises one or more induction heating elements (for example heating element 324 in FIGS. 10B and 10C). As shown in FIGS. 10B and 10C, the heating element 324 is provided within, or forms part of, the base portion 308. However, alternatively or in addition to, one or more induction heating elements may be provided in the lid portion 306. Accordingly, the lid portion 306 and the base portion 308 are engaged so as to prevent relative movement of the aerosol generating article along a direction towards or away from the one or more heating elements, for example preventing movement of the article 304 along the z direction (when in use) away or towards the heating element 324 of device 302 as indicated in FIG. 10C. Although only one induction heating element 324 is shown in FIGS. 10B and 10C, it will be understood that more than one induction heating element 324, such as two or three induction heating elements may be provided. The one or more induction heating elements comprise one or more inductor coils for generating a varying magnetic field so as to heat, in use, one or more susceptor elements of an aerosol generating article (such as a metallic foil) held in position by the securing mechanism. As shown in FIG. 10B, the induction heating element 324 may comprise a trapezoidal induction heating element similar to FIG. 9A or 9B.

The one or more induction heating elements 324 define a planar surface, as shown in FIGS. 10B and 10C. Accordingly, in use, the securing mechanism is configured to engage the lid portion 306 with the base portion 308 so as to hold in position parallel to the planar surface a substantially planar aerosol generating article 304 (as shown in FIG. 10C) so as to prevent relative movement of the substantially planar aerosol generating article along a direction substantially perpendicular to the planar surface, such as along the z-direction as shown in FIG. 10C.

As will be understood, the one or more induction heating elements may comprise substantially planar heating elements, such as a flat spiral induction coil. However, in other embodiments, the one or more heating elements 324 may be non-planar but which define a planar surface, such as a conical induction coil wherein the base of the conical coil defines the planar surface.

As shown in FIGS. 10B and 10C, the aerosol provision device 303 comprises a rotating device 330 configured to rotate, about a rotation axis, the aerosol generating article 304 (as indicated in FIG. 10C). The rotation device rotating device 330 is configured to rotate the aerosol generating article 304 relative to the induction heating element so that one or more fresh aerosol generating regions of the aerosol generating article 304 are moved into proximity to the heating element. As will be understood, in embodiments comprising a rotating device 330, the securing mechanism is configured to enable the aerosol generating article 304 to be rotated relative to the heating element whilst preventing relative movement of the aerosol generating article in a direction other than rotation about the rotation axis, such as in the z-direction as indicated in FIG. 10C.

The lid portion 306 may comprise a plenum 322 and a mouthpiece 314. The plenum 322 may comprise the mouthpiece 314. In some embodiments, the mouthpiece 314 and plenum 322 may be integral with the lid portion 306.

The securing mechanism may comprise a hinge 334 such that the lid portion 306 is connected to the base portion 308 through the hinge 334 so as to form a clamshell arrangement. That is, the device 303 may be configured to receive an aerosol generating article 304 when the hinge 334 is in an open position, e.g., as shown going in FIGS. 10B and 10C. The securing mechanism may be configured to engage the lid portion 306 with the base portion 308 so as to hold in position, in use, an aerosol generating article 304 within a receptacle formed by the lid 306 and base 308 portions so as to prevent relative movement of the aerosol generating article when the hinge 334 is in a closed position.

As shown in FIG. 10C, an electromagnetic shield member 402 may substantially cover the surface of the planar inductor coil 324 facing away from the article 304 in use. The electromagnetic shield member 402 may comprise one or more components consisting of one or more polymeric compositions. Other than the specific shape, the electromagnetic shield member 402 may function in a similar manner as described above in reference to FIGS. 6-8.

In embodiments, the aerosol provision device 303 may additionally or alternatively comprise one or more further electromagnetic shield members 402a, 402b in the lid portion and/or the base portion configured to absorb or reflect electromagnetic radiation passing through the lid portion and/or the base portion.

In an embodiment, as shown in FIG. 10C, the lid portion 306 may comprise one or more first gripping elements in the form of protrusion 328 configured to grip one or more second gripping elements in the form of lip 333 provided in the base portion 308. As will be understood, the protrusion 328 and lip 333 may also comprise one or more further electromagnetic shield members (not shown).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device comprising:
a receptacle configured to receive aerosol generating material, wherein the aerosol generating material is heatable by a susceptor;
an inductor coil configured to generate a varying magnetic field for heating the susceptor; and
an electromagnetic shield member at least partially covering the inductor coil, wherein the electromagnetic shield member comprises a polymeric composition which is configured to absorb and/or reflect electromagnetic radiation.

2. An aerosol provision device according to claim 1, wherein the polymeric composition comprises (i) a polymer and (ii) filler which is capable of absorbing and/or reflecting electromagnetic radiation.

3. An aerosol provision device according to claim 1, wherein the polymeric composition has a shielding effectiveness of at least about 20 dB, when measured at 30 MHz.

4. (canceled)

5. An aerosol provision device according to claim 3, wherein the polymeric composition has a shielding effectiveness of from about 30 to about 80 dB, when measured at 30 MHz.

6. (canceled)

7. An aerosol provision device according to claim 1, wherein the polymeric composition has a surface resistance of about 10⁵ Ohm or less.

8. (canceled)

9. (canceled)

10. An aerosol provision device according to claim 1, wherein the polymeric composition has a surface resistance of from about 0.01 to about 10 Ohm.

11. An aerosol provision device according to claim 1, wherein the polymeric composition has a thickness of from about 0.10 to about 2 mm.

12. (canceled)

13. An aerosol provision device according to claim 1, wherein the electromagnetic shield member is in contact with the inductor coil.

14. An aerosol provision device according to claim 2, wherein the polymer is an elastomer or a thermoplastic polymer.

15. An aerosol provision device according to claim 2, wherein the polymer is selected from the group consisting of polycarbonate (PC), polyethylenimine (PEI), acrylonitrile butadiene styrene (ABS), polystyrene (PS), polyvinyl chloride (PVC), PVC alloys, cyclic olefin copolymer (COC), poly(methyl methacrylate) (PMMA), polypropylene carbonate (PPC), polyether ether ketone (PEEK), polybutylene terephthalate (PBT), polyethylene terephthalate (PET), polyoxymethylene (POM), nylon), polyethylene (PE), polypropylene (PP), thermoplastic polyurethane (TPU), silicone, and combinations thereof.

16. (canceled)

17. An aerosol provision device according to claim 2, wherein the filler is electrically conductive.

18. An aerosol provision device according to claim 17, wherein the filler has a surface resistance of about 10⁻⁴ Ohms or less.

19. An aerosol provision device according to claim 2, wherein the filler is selected from the group consisting of a metal or an alloy thereof, carbon, a carbide, a nitride, an oxide, MXene, and combinations thereof.

20. (canceled)

21. (canceled)

22. (canceled)

23. (canceled)

24. (canceled)

25. An aerosol provision device according to claim 1, further comprising the susceptor, wherein the susceptor defines the receptacle.

26. An aerosol provision device according to claim 1, further comprising an outer cover forming at least a portion of an outer surface of the aerosol provision device, wherein an outer surface of the outer cover is positioned away from an outer surface of the susceptor.

27. An aerosol provision device according to claim 26, wherein in use, a temperature of the outer surface remains below about 70° C., 60° C., 55° C. or about 48° C.

28. An aerosol provision device according to claim 1, wherein the inductor coil is a substantially helical coil extending around the receptacle, and wherein the electromagnetic shield member extends at least partially around the inductor coil.

29. An aerosol provision device according to claim 1, wherein the inductor coil is a substantially planar coil defining a first substantially planar surface on a first side of the inductor coil, a second substantially planar surface on a second side of the inductor coil opposite the first side, and a perimeter surface connecting the first and second substantially planar surfaces; and
wherein the electromagnetic shield member at least partially covers one or more of the first substantially planar surface, the second substantially planar surface, and the perimeter surface.

30. An aerosol provision system, comprising an aerosol provision device according to claim 1, and an article comprising aerosol generating material.

31. An electromagnetic shield member for an aerosol provision device, wherein the electromagnetic shield member comprises a polymeric composition which is configured to absorb and/or reflect electromagnetic radiation, as defined in claim 1.

32. (canceled)
